(19) United States
(12) Patent Application Publication
(10) Pub. No.: US 2014/0142916 A1
(43) Pub. Date: May 22, 2014

(54) COMPUTING DEVICE AND METHOD FOR AUTOMATICALLY MARKING SIGNAL TRANSMISSION LINE

(71) Applicants: HONG FU JIN PRECISION INDUSTRY(ShenZhen) CO., LTD., (US); HON HAI PRECISION INDUSTRY CO., LTD., New Taipei (TW)

(72) Inventor: JIAN-SHE SHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/730,671

(22) Filed: Dec. 28, 2012

(30) Foreign Application Priority Data
Nov. 20, 2012 (CN) 2012104719880

(51) Int. Cl. G06F 17/50

(52) U.S. Cl. CPC G06F 17/5009
USPC 703/14

(57) ABSTRACT

A computer-based method for marking signal transmission lines of a printed circuit board (PCB) layout includes: reading names of to-be-checked signal transmission lines in a name file; determining the to-be-checked signal transmission lines in a displayed PCB layout according to the read names; and marking the determined to-be-checked signal transmission lines in the displayed PCB layout. A related computing device is also provided.

### BACKGROUND

1. Technical Field

Embodiments of the present disclosure relates to circuit simulation systems and methods, and more particularly, to a computing device and a method for automatically marking to-be-checked signal transmission lines in a printed circuit board (PCB) layout.

2. Description of related art

Quality of some signal transmission lines should be checked in a PCB layout in designing the PCB layout. Generally, selecting to-be-checked signal transmission lines in a displayed PCB layout is often visually done by a technician, which is not only time-consuming, but also error-prone.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of one embodiment of a computing device for automatically marking signal transmission lines of a PCB layout.

FIG. 2 is a block diagram of one embodiment of function modules of a marking system.

FIG. 3 is a flowchart of one embodiment of a method for automatically marking signal transmission lines of a PCB layout.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

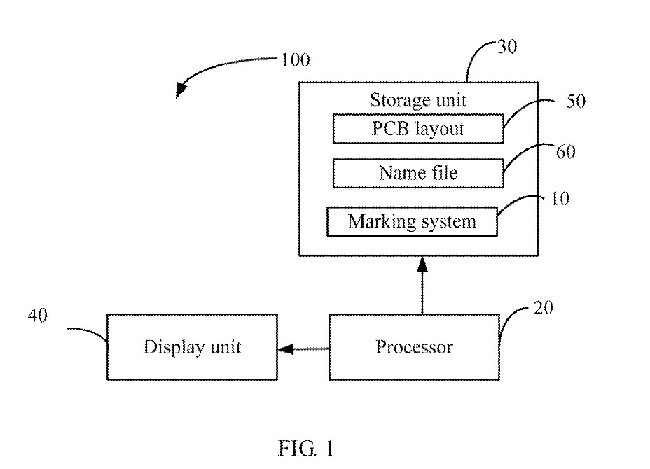

FIG. 1 is a block diagram of one embodiment of a computing device 100. The computing device 100 includes a processor 20, a storage unit 30, and a display unit 40. The storage unit 30 may be a computer, a smart media card, a secure digital card, or a flash card. The storage unit 30 stores computerized codes of a marking system 10, at least one PCB layout 50, and a name file 60. The name file 60 records names of to-be-checked signal transmission lines. The marking system 10 includes various software components and/or a set of instructions, which may be implemented by the processor 20 to automatically determine to-be-checked signal transmission lines according to the name file 60 and automatically mark the determined to-be-checked signal transmission lines.

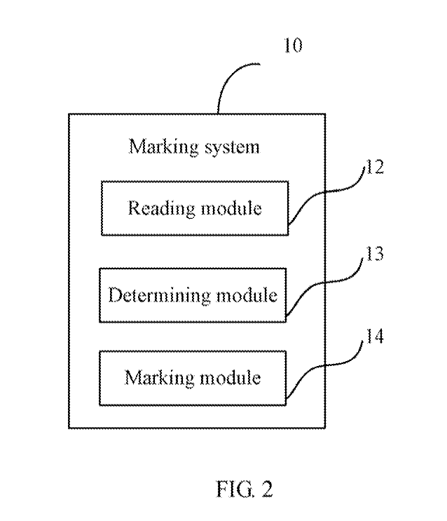

FIG. 2 is a block diagram of the function modules of the marking system 10 in the computing device 100 of FIG. 1. In one embodiment, the marking system 10 includes a reading module 12, a determining module 13, and a marking module 14.

The reading module 12 includes various software components and/or set of instructions, which may be implemented by the processor 20 to read the names of to-be-checked signal transmission lines in the name file 60.

The determining module 13 includes various software components and/or a set of instructions, which may be implemented by the processor 20 to determine the to-be-checked signal transmission lines in a PCB layout displayed on the display unit 40 according to the read names.

The marking module 14 includes various software components and/or a set of instructions, which may be implemented by the processor 20 to mark the determined to-be-checked signal transmission lines in the displayed PCB layout. In this embodiment, the marking module 14 is implemented by the processor 20 to firstly mark the determined to-be-checked signal transmission line recorded by name in a first position of the name file in the displayed PCB layout, and then mark the remaining determined to-be-checked signal transmission lines in the displayed PCB layout in response to user input. In an alternative embodiment, the marking module 14 is implemented by the processor 20 to mark the determined to-be-checked signal transmission lines in the displayed PCB layout simultaneously. The marking module 14 is implemented by the processor 20 to mark the to-be-checked signal lines by highlighting the to-be-checked signal transmission lines in the displayed PCB layout.

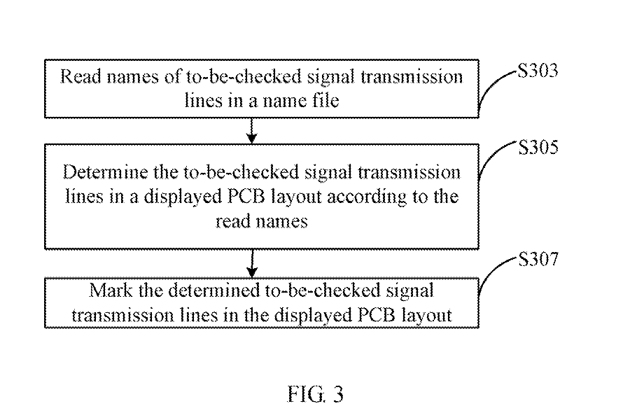

FIG. 3 is a flowchart of one embodiment of a method for marking to-be-checked signal transmission lines in a PCB layout. Depending on the embodiment, additional blocks may be added, others removed, and the ordering of the blocks may be changed.

In block S301, the reading module 12 is implemented by the processor 20 to read the names of to-be-checked signal transmission lines in the name file 60.

In block S302, the determining module 13 is implemented by the processor 20 to determine the to-be-checked signal transmission lines in a displayed PCB layout according to the read names.

In block S303, the marking module 14 is implemented by the processor 20 to mark the determined to-be-checked signal transmission lines in the displayed PCB layout. In this embodiment, the marking module 14 is implemented by the processor 20 to firstly mark the determined to-be-checked signal transmission line recorded by name in a first position of the name file in the displayed PCB layout, and then mark the remaining determined to-be-checked signal transmission lines in the displayed PCB layout in response to user input. In an alternative embodiment, the marking module 14 is implemented by the processor 20 to mark the determined to-be-checked signal transmission lines in the displayed PCB layout simultaneously. The marking module 14 is implemented by the processor 20 to mark the to-be-checked signal lines by highlighting the to-be-checked signal transmission lines in the displayed PCB layout.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-based method for marking signal transmission lines of a printed circuit board (PCB) layout, the method comprising:
reading names of to-be-checked signal transmission lines in a name file;
determining the to-be-checked signal transmission lines in a displayed PCB layout according to the read names; and
marking the determined to-be-checked signal transmission lines in the displayed PCB layout.

2. The method as claimed in claim 1, wherein the determined to-be-checked signal transmission line which name is recorded in a first position of the name file is firstly marked in the displayed PCB layout, and the remaining determined to-be-checked signal transmission lines are then marked in response to user input.

3. The method as described in claim 1, wherein the determined to-be-checked signal transmission lines are simultaneously marked in the displayed PCB layout.

4. The method as claimed in claim 1, wherein the determined to-be-checked signal transmission lines are marked by highlighting the determined to-be-checked signal transmission lines in the displayed PCB layout.

5. A computing device, comprising:
a storage device;
at least one processor; and
a marking system comprising computerized code in the form of one or more programs, which are stored in the storage device and executable by the at least one processor, the one or more programs comprising:
a reading module to read names of to-be-checked signal transmission lines in a name file stored in the storage device;
a determining module to determine the to-be-checked signal transmission lines in a displayed PCB layout according to the read names; and
a marking module to mark the determined to-be-checked signal transmission lines in the displayed PCB layout.

6. The computing device as claimed in claim 5, wherein the marking module is to firstly mark the determined to-be checked signal transmission line which name is recorded in a first position of the name file, and, and the remaining determined to-be-checked signal transmission lines are then marked in response to user input.

7. The computing device as claimed in claim 5, wherein the marking module is to simultaneously mark the determined to-be-checked signal transmission lines in the displayed PCB layout.

8. The computing device as described in claim 5, wherein the marking module is to mark the determined to-be-checked signal transmission lines by highlighting the to-be-checked signal transmission lines in the displayed PCB layout.
